(19) United States
(12) Patent Application Publication
(10) Pub. No.: US 2016/0209541 A1
(43) Pub. Date: Jul. 21, 2016

(54) Determining Location and Depth of Subsurface Magnetic Sources

(71) Applicant: UNIVERSITY OF THE WITWATERSRAND, JOHANNESBURG, Johannesburg (ZA)

(72) Inventor: Gordon Robert John Cooper, Randburg (ZA)

(21) Appl. No.: 14/916,686

(22) PCT Filed: Mar. 24, 2014
(86) PCT No.: PCT/IB2014/060078

§ 371 Date: Mar. 4, 2016

(51) Int. Cl. G01V 3/38; G01V 3/16

(52) U.S. Cl. CPC G01V 3/38; G01V 3/16

(57) ABSTRACT

The present invention relates to a method for locating magnetic bodies within the earth and in particular to a method for determining the subsurface location, geometry and depth of these bodies from aeromagnetic data. The method includes accessing aeromagnetic data and processing the data according to the described equations to determine the subsurface location, geometry and depth of these bodies.

### BACKGROUND OF THE INVENTION

The present invention relates to a method for locating magnetic bodies within the earth and in particular to a method for determining the subsurface location, geometry and depth of these bodies from aeromagnetic data.

The method specifically relates to locating bodies buried in the subsurface by analysing their effect upon the ambient magnetic field of the Earth. The strength of the Earth's magnetic field has been measured across almost all of the Earth's land surface using ground and airborne based systems. Once the raw data has been collected it must be interpreted, which is performed using standard techniques such as modelling and inversion. However these techniques require initial estimates of the parameters of the magnetic bodies (such as their location, depth, dip, and susceptibility) to be effective. There are a variety such semiautomatic interpretation techniques available, but they all have restrictions or problems, such as only working with profile data, or being restricted to a specific source type, or failing in the presence of remnant magnetisation (the magnetisation which some rocks possess even in the absence of the geomagnetic field).

The present invention provides an improved method and system to address this.

### SUMMARY OF THE INVENTION

According to one example embodiment, a system for interpreting aeromagnetic data, the system including:
a memory for storing therein aeromagnetic data; and
a data processor for accessing the data stored in the memory and processing the data according to the following formulae:

$$r = \frac{{NAs}_{0}}{As}$$

where r represents the depth of the magnetic source;
N is a structural index, which defines the type of source;
As is the analytic signal amplitude of the magnetic field f, given by:

$$As = \sqrt{{( \frac{\partial f}{\partial x} )}^{2} + {( \frac{\partial f}{\partial y} )}^{2} + {( \frac{\partial f}{\partial z} )}^{2}}$$

and As₀ is the zero-order analytic signal amplitude given by:

As₀=\sqrt{f²+Hₓ²+H_{y}²}

where Hₓ and H_{y} are two orthogonal Hilbert transforms of the data.

According to another example embodiment, a system for interpreting aeromagnetic data, the system including:
a memory for storing therein aeromagnetic data; and
a data processor for accessing the data stored in the memory and processing the data according to the following formulae:

$$r = \frac{( N + 1 ) As}{{As}_{2}}$$

where r represents the depth of the magnetic source;
N is a structural index, which defines the type of source;
As is the analytic signal amplitude of the magnetic field f, given by:

$$As = \sqrt{{( \frac{\partial f}{\partial x} )}^{2} + {( \frac{\partial f}{\partial y} )}^{2} + {( \frac{\partial f}{\partial z} )}^{2}}$$

and As₂ is the second order analytic signal amplitude given by:

$${As}_{2} = \sqrt{{( \frac{\partial As}{\partial x} )}^{2} + {( \frac{\partial As}{\partial y} )}^{2} + {( \frac{\partial As}{\partial z} )}^{2}}$$

According to another example embodiment, a system for interpreting aeromagnetic data, the system including:
a memory for storing therein aeromagnetic data; and
a data processor for accessing the data stored in the memory and processing the data according to the following formulae:

$$r = \frac{( N + 1 )}{{As}_{T}}$$

where r represents the depth of the magnetic source;
N is a structural index, which defines the type of source;
and AsT is the analytic signal amplitude of the Tilt Angle T where:

$$T = {tan}^{- 1} ( \frac{\frac{\partial f}{\partial z}}{\sqrt{( {( \frac{\partial f}{\partial x} )}^{2} + {( \frac{\partial f}{\partial y} )}^{2} )}} )$$

$$and$$

$${As}_{T} = \sqrt{{( \frac{\partial T}{\partial x} )}^{2} + {( \frac{\partial T}{\partial y} )}^{2} + {( \frac{\partial T}{\partial z} )}^{2}}$$

According to another example embodiment, a system for interpreting aeromagnetic data, the system including:
a memory for storing therein aeromagnetic data; and
a data processor for accessing the data stored in the memory and processing the data according to the following formulae:

$${T}_{As} = {tan}^{- 1} ( \frac{\frac{\partial As}{\partial z}}{\sqrt{( {( \frac{\partial As}{\partial x} )}^{2} + {( \frac{\partial As}{\partial y} )}^{2} )}} )$$

where T_{AS} is the tilt angle and Δx and Δz are the horizontal and vertical distances to a magnetic body; and
once the T_{AS} has been calculated then the data processor calculates the depth to the magnetic sources by measuring a distance between contour lines of user-specified value.

### BRIEF DESCRIPTION OF THE DRAWINGS

FIG. 1 is a block diagram illustrating an example server to implement the present invention;

FIG. 2 shows aeromagnetic data captured from a portion of the eastern limb of the Bushveld Igneous Complex in South Africa;

FIG. 3 shows a plot comparing the output of the Euler deconvolution method with r;

FIG. 4 shows the distance to the magnetic sources beneath the surface in the data shown in FIG. 2;

FIG. 5 on the left of the drawing shows an aeromagnetic dataset from the Karoo and on the right is the T_{AS} with the depth to all magnetic source types is given by measuring the width of the red portions; and

FIG. 6-9 show method steps of different embodiments carried out by the data processing module of FIG. 1.

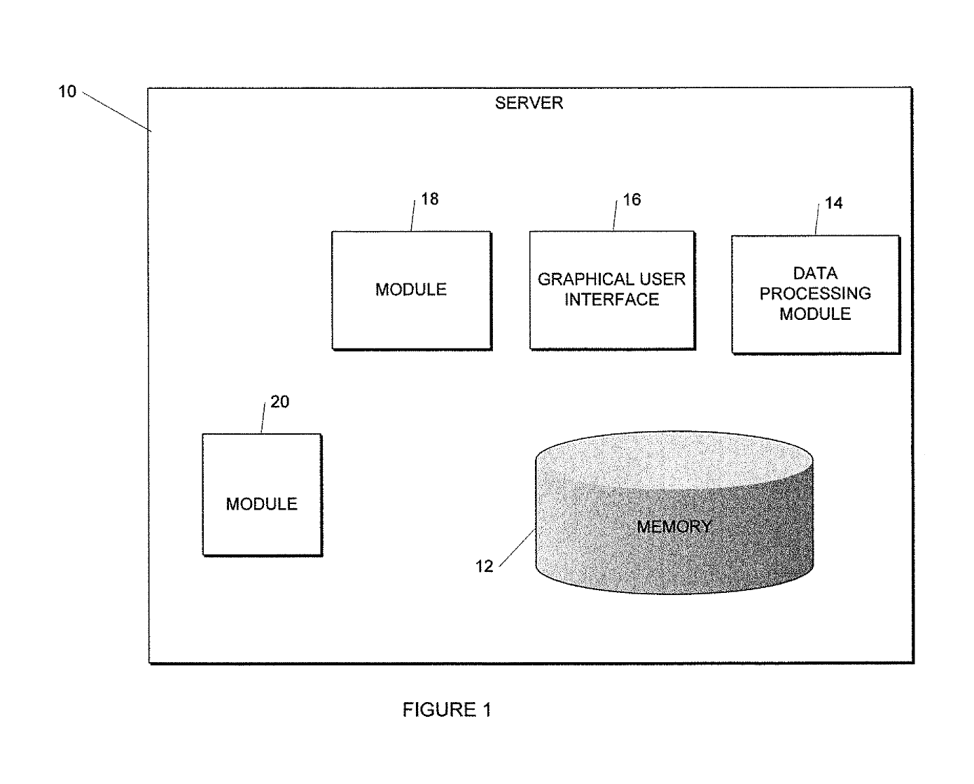

### DESCRIPTION OF EMBODIMENTS

The systems and methodology described herein relate to locating magnetic bodies within the earth and in particular to a method for determining the subsurface location, geometry and depth of these bodies from aeromagnetic data.

Referring to the accompanying Figures, a system for interpreting aeromagnetic data includes a server 10 that includes a number of modules to implement the present invention and an associated memory 12.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules may form a physical apparatus with physical modules specifically for executing the steps of the method described herein.

The memory 12 has stored therein aeromagnetic data.

Aeromagnetic data acquisition systems currently acquire the strength of the Earth's magnetic field over a survey area, and also the positions at which the field values were recorded. The aeromagnetic data will therefore typically include position data and magnetic field strength data with the data being time together so that it is known what magnetic field strength was measured at a particular position.

The most common positional data used is a grid which will then include an x and a y measurement. Another example of positional data is the location of an aircraft including its height when an aeromagnetic data reading was taken.

It is also common nowadays to directly measure the gradients of the magnetic field i.e the df/dx, df/dy, and df/dz terms that appear in the equations below. However if they are not measured they can be calculated numerically.

In any event, a data processor 14 accesses the data stored in the memory and processes the data according to the following formulae.

$$r = \frac{{NAs}_{0}}{As} \qquad ( 1 )$$

In this equation r represents the distance to the magnetic source. When r is at a minimum it represents the depth to the source.

N is the structural index, which defines the type of source. Examples of N are:

N=0 for a contact which is a geological term that describes the surface between two different rock types; in this context they are of considerable lateral extent;

N=1 for a dyke which is a thin sheet of lava in the ground, a dyke will be relatively thin in the direction of dip unlike a contact; and

N=3 which is a dipole which is a point source in ground.

Thus, for example, if a survey was looking for Kimberlite which is an igneous rock best known for sometimes containing diamonds, this is often a vertical pipe and N would be set to equal 1.

As is the analytic signal amplitude. The analytic signal amplitude can be thought of as the magnitude of the gradients of the magnetic field f, and is given by:

$$As = \sqrt{{( \frac{\partial f}{\partial x} )}^{2} + {( \frac{\partial f}{\partial y} )}^{2} + {( \frac{\partial f}{\partial z} )}^{2}}$$

As₀ is the zero-order analytic signal amplitude, i.e.

As₀=\sqrt{f²+Hₓ²+H_{y}²}

where Hₓ and H_{y} are two orthogonal Hilbert transforms of the data.

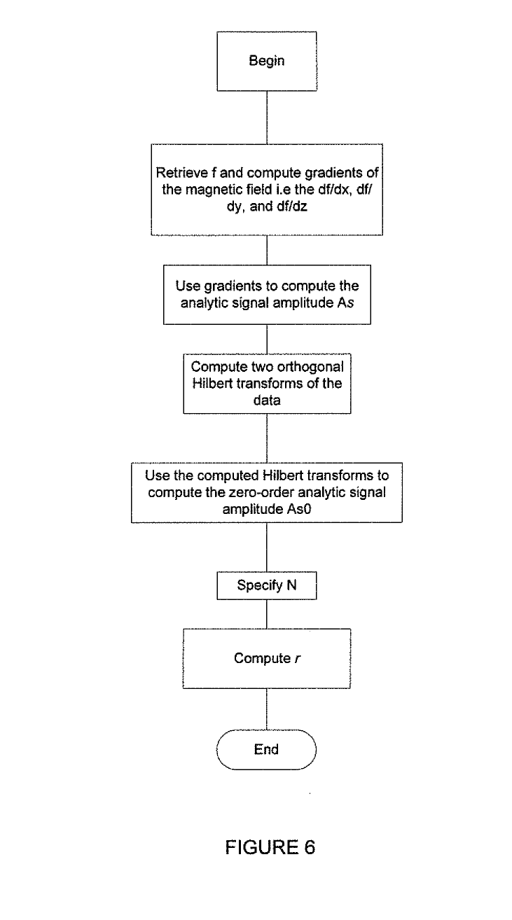

In order to implement the calculation of the above formulae, the data processor 14 carries out the method steps as illustrated in FIG. 6.

Firstly the data processor 14 retrieves the f value from the memory 12 and computes the gradients of the magnetic field i.e the df/dx, df/dy, and df/dz.

Alternatively, these gradients of the magnetic field also retrieved from the memory 12 for each corresponding f value.

Next, the data processor 14 uses the gradients to compute the analytic signal amplitude As.

Once this is done, the two orthogonal Hilbert transforms of the data are computed.

The data processor 14 then use the computed Hilbert transforms to compute the zero-order analytic signal amplitude As₀.

Finally, N is specified and the data processor 14 will calculate the relevant r value.

It will be appreciated that the data processor 14 will reiterate these functional method steps for each value of f stored in the memory 12.

In this way, for each geographic location a depth r to the magnetic source can be calculated.

In a second example embodiment, the depth r to the magnetic source can be calculated as follows.

$$r = \frac{( N + 1 ) As}{{As}_{2}} \qquad ( 2 )$$

where As₂ is the second order analytic signal amplitude given by:

$${As}_{2} = \sqrt{{( \frac{\partial As}{\partial x} )}^{2} + {( \frac{\partial As}{\partial y} )}^{2} + {( \frac{\partial As}{\partial z} )}^{2}}$$

The second order analytic signal amplitude can be thought of as the magnitude of the gradients of the analytic signal amplitude.

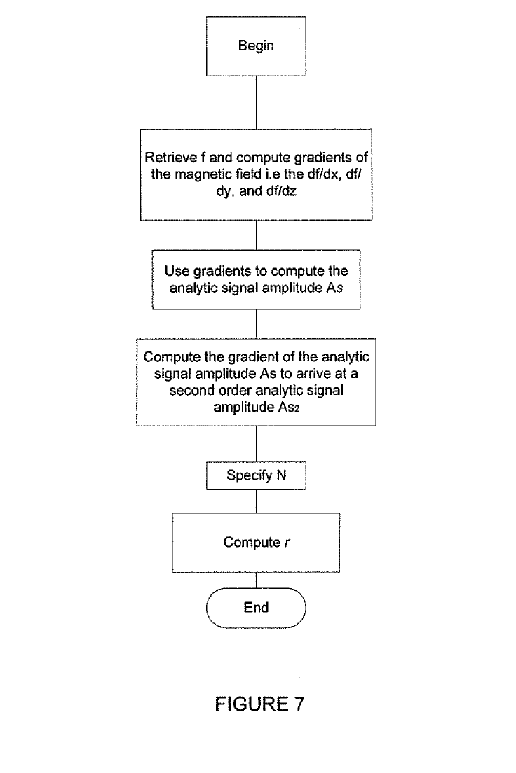

In order to implement the calculation of the above formulae, the data processor 14 carries out the method steps as illustrated in FIG. 7.

Firstly the data processor 14 retrieves the f value from the memory 12 and computes the gradients of the magnetic field i.e the df/dx, df/dy, and df/dz .

Alternatively, these gradients of the magnetic field also retrieved from the memory 12 for each corresponding f value.

Next, the data processor 14 uses the gradients to compute the analytic signal amplitude As.

Once this is done, the data processor 14 will compute the gradients of the analytic signal amplitude As to arrive at the second order analytic signal amplitude As₂.

Finally, N is specified and the data processor 14 will calculate the relevant r value.

It will be appreciated that these two equations (1) and (2) above give the distance to a magnetic source of known type using only the field f and combinations of its gradients. These gradients are simple to calculate, and it is common to measure them directly in modern airborne surveys.

However, equation 1 has problems in that it requires accurate regional (background) field removal, and secondly it does not work for geological contacts (because N=0).

As second order derivatives are sensitive to noise, in one example embodiment both these equations may be used in conjunction and then the results compared.

In a further embodiment, r may be calculated as follows

$$r = \frac{( N + 1 )}{{As}_{T}} \qquad ( 3 )$$

where AsT is the analytic signal amplitude of the Tilt Angle T. The Tilt-angle is an amplitude balanced vertical derivative, and is primarily used as an image enhancement tool for magnetic data. In itself it provides no information as to the depth of magnetic sources.

$$T = {tan}^{- 1} ( \frac{\frac{\partial f}{\partial z}}{\sqrt{( {( \frac{\partial f}{\partial x} )}^{2} + {( \frac{\partial f}{\partial y} )}^{2} )}} )$$

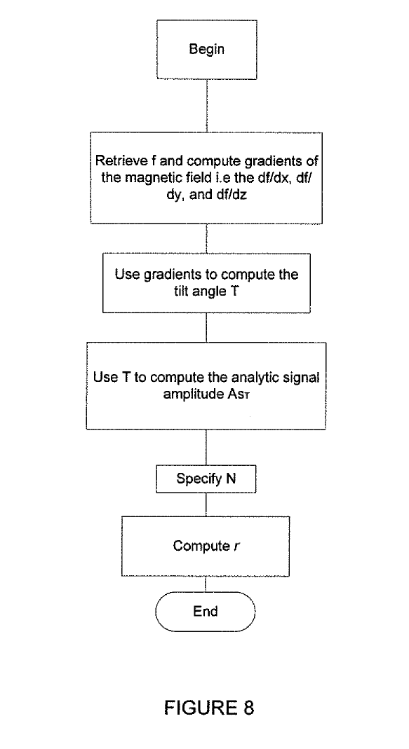

In order to implement the calculation of the above formulae, the data processor 14 carries out the method steps as illustrated in FIG. 8.

Firstly the data processor 14 retrieves the f value from the memory 12 and computes the gradients of the magnetic field i.e the df/dx, df/dy, and df/dz.

Alternatively, these gradients of the magnetic field also retrieved from the memory 12 for each corresponding f value.

Next, the data processor 14 uses the gradients to compute the Tilt Angle T.

Once this is done, the data processor 14 will use the gradients of the Tilt Angle T to compute the analytic signal amplitude AsT of the Tilt Angle T.

$${A}_{ST} = \sqrt{{( \frac{\partial T}{\partial x} )}^{2} + {( \frac{\partial T}{\partial y} )}^{2} + {( \frac{\partial T}{\partial z} )}^{2}}$$

Finally, N is specified and the data processor 14 will calculate the relevant r value.

The equations 1, 2, and 3 are unaffected by the source dip and magnetisation vector.

Some existing semi-automatic interpretation methods require that the source have vertical sides and/or that the geomagnetic field be vertical at the source location. Equations 1, 2 and 3 do not have these severe restrictions.

Once r is known it can be graphically displayed using location information obtained from the aeromagnetic data which is captured at the same time as the other data.

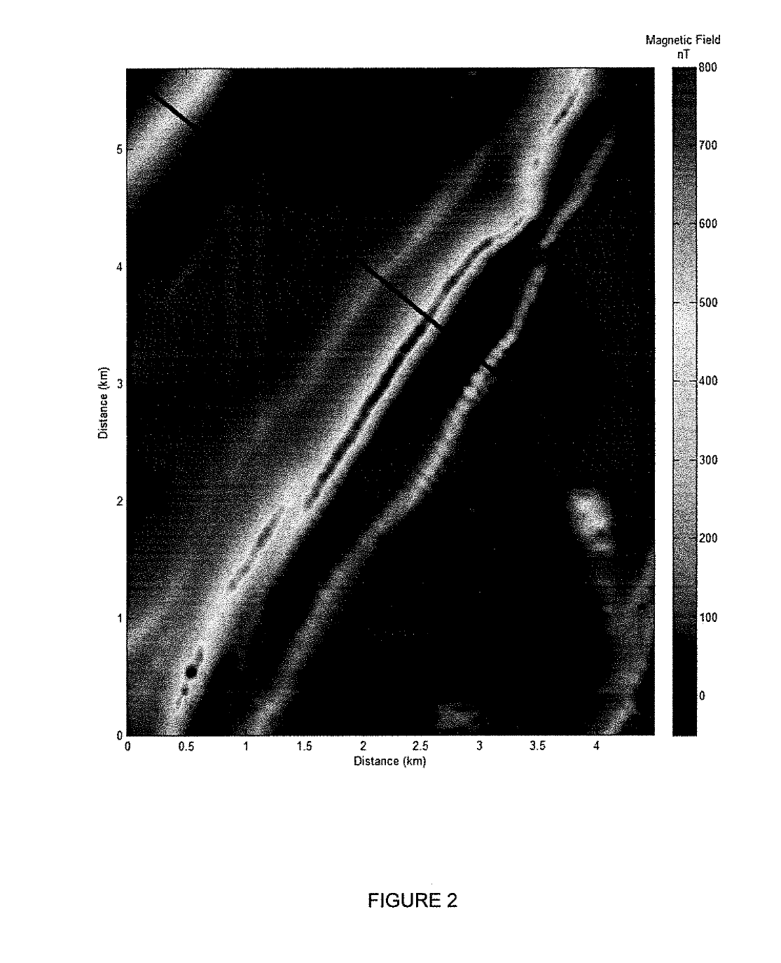

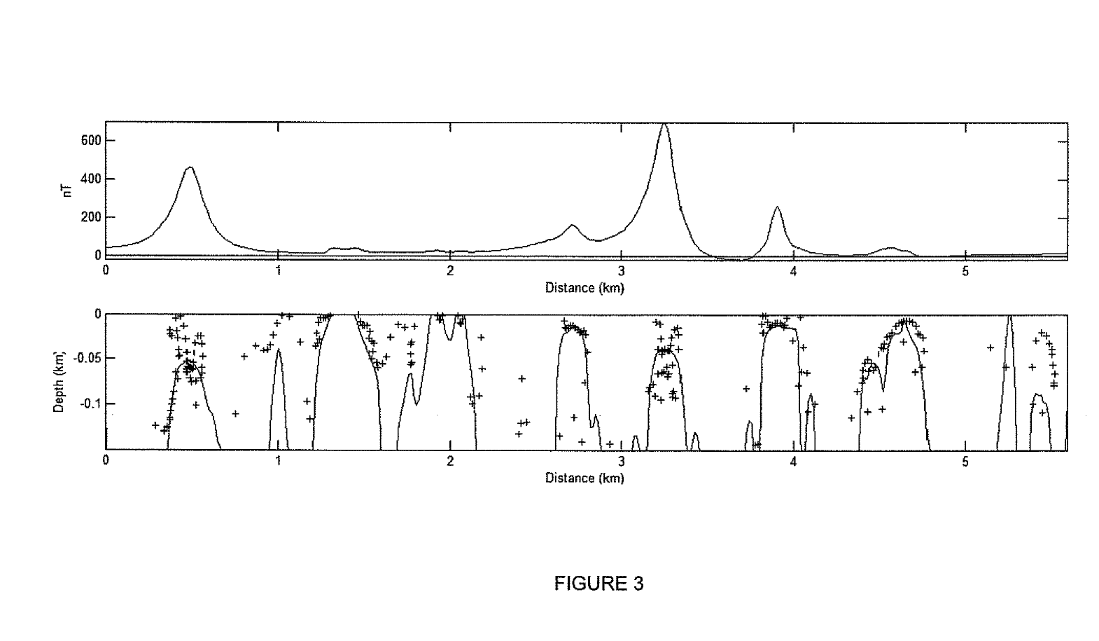

In an example of the above, FIG. 2 shows aeromagnetic data captured from a portion of the eastern limb of the Bushveld Igneous Complex in South Africa. The black line shows the location of the magnetic profile plotted in FIG. 3.

Referring to FIG. 3, the lower portion of the plot compares the output of Euler deconvolution (black+symbols) with r (black solid line). The geological structure is clearly revealed, and the dykes can be seen.

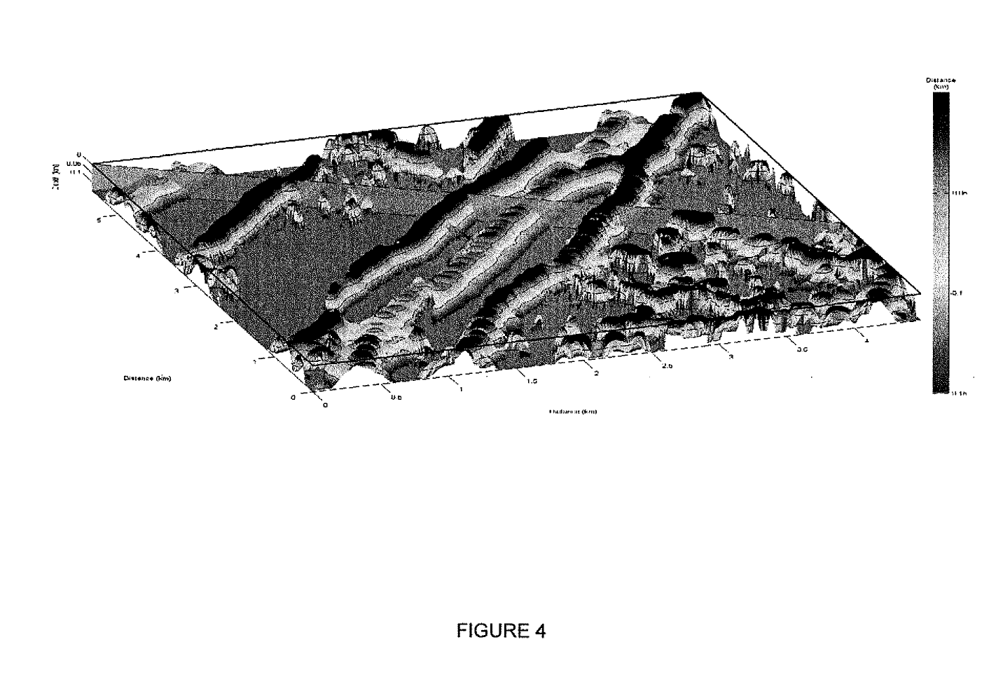

FIG. 4 shows the distance to the magnetic sources beneath the surface in the data shown in FIG. 2. The dykes are clearly visible as linear features trending from the SW to the NE. the location of the profile shown in FIG. 3 is shown as a transparent rectangle trending from the NW to the SE.

The data processor 14 will use the values of r calculated above together with position data described above to generate the display to be displayed to the user via graphical user interface 16.

In an alternate embodiment a differing approach is used to remove the need to know the structural index N included in the three equations above.

Salem et al [Salem, A., Williams, S., Fairhead, J. D., and Ravat, D., 2007. Tilt-depth method: A simple depth estimation method using first-order magnetic derivatives. The Leading Edge, October, 1502-1505.] introduced the Tilt-depth method. They showed that, for a vertically magnetised, vertically dipping contact that the Tilt angle became:

$$T = {tan}^{- 1} ( \frac{Δ x}{Δ z} )$$

where Δx and Δz are the horizontal and vertical distances to the contact. The depth to the contact was then taken as half the distance between the ±45° contours of T.

In an alternate embodiment of the present invention, the Tilt angle of the analytic signal amplitude is calculated, ie,

$${T}_{As} = {tan}^{- 1} ( \frac{\frac{\partial As}{\partial z}}{\sqrt{( {( \frac{\partial As}{\partial x} )}^{2} + {( \frac{\partial As}{\partial y} )}^{2} )}} )$$

For a contact, dyke, or source of type 1/r^{N}, the T_{AS} becomes:

$${T}_{As} = {tan}^{- 1} ( \frac{Δ z}{Δ x} )$$

The source location is then given by the T_{AS}=90° contour (because Δx=0), and its depth is obtained by measuring the distance between the contours of the T_{AS} in a similar manner to that of the Tilt-depth method. As well as working for other geological models, another important advantage of the T_{AS} method is that it is not restricted to vertically magnetised and vertically dipping structures. Most importantly, the source type does not have to be a priori specified.

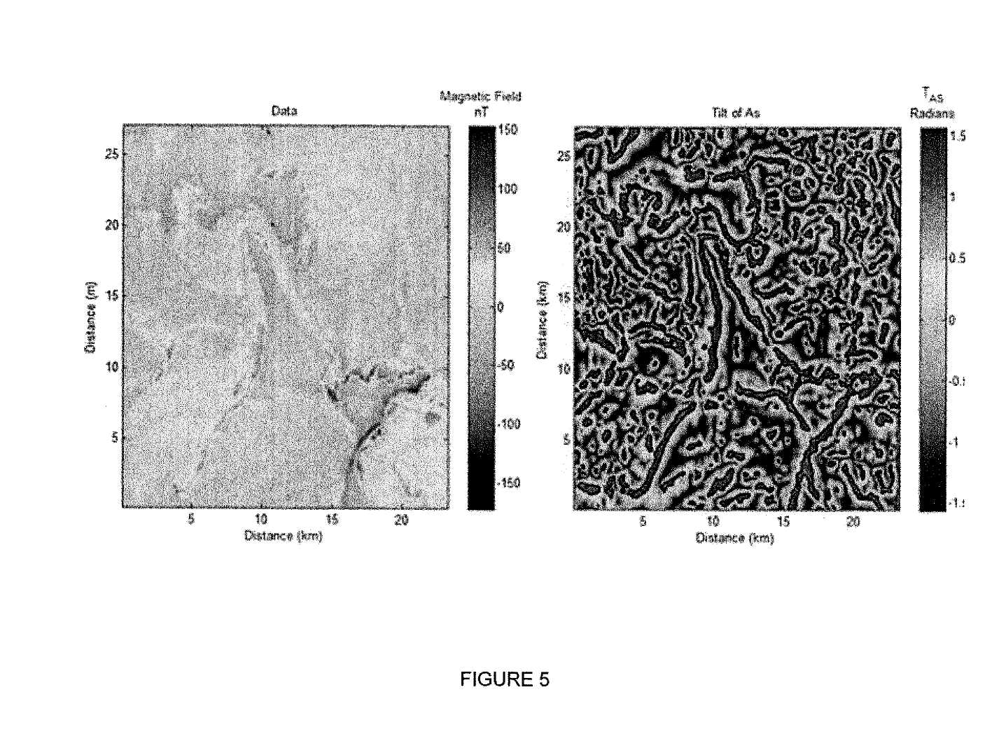

Referring to FIG. 5, the image on the left shows an aeromagnetic dataset from the Karoo. On the right is the T_{AS}. The depth to all magnetic source types is given by measuring the width of the red portions.

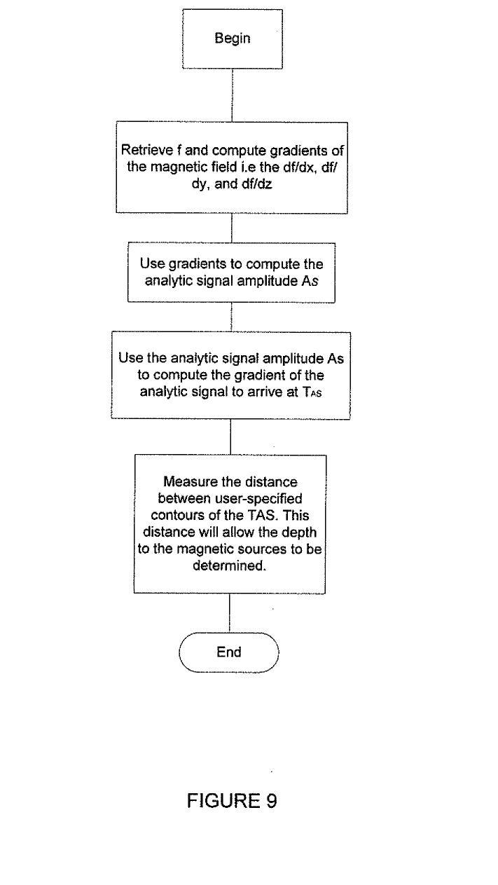

In order to implement the calculation of the above formulae, the data processor 14 carries out the method steps as illustrated in FIG. 9.

Firstly the data processor 14 retrieves the f value from the memory 12 and computes the gradients of the magnetic field i.e the df/dx, df/dy, and df/dz.

Alternatively, these gradients of the magnetic field also retrieved from the memory 12 for each corresponding f value.

Next, the data processor 14 uses the gradients to compute the analytic signal amplitude As.

Once this is done, the data processor 14 will use the analytic signal amplitude As is used to compute the gradient of the analytic signal amplitude As to arrive at the TAS.

Next the data processor 14 will measure the distance between user-specified contours of the TAS. This distance will allow the depth to the magnetic sources to be determined.

The use of the T_{AS} to determine the depth to the magnetic sources is complementary to the use of equations 1-3 in that it does not require the source type to be a priori specified. However its need to measure the distance between contour lines to determine the source depth means that the method is more difficult to implement than the simple evaluation of equations 1-3 at each point in space.

1. A system for interpreting aeromagnetic data, the system comprising:
a memory for storing therein aeromagnetic data; and
a data processor for accessing the data stored in the memory and processing the data according to the following formulae:
$$r = \frac{{NAs}_{0}}{As}$$
where r represents a depth of the magnetic source;
N is a structural index, which defines a type of source;
As is an analytic signal amplitude of a magnetic field f, given by:
$$As = \sqrt{{( \frac{\partial f}{\partial x} )}^{2} + {( \frac{\partial f}{\partial y} )}^{2} + {( \frac{\partial f}{\partial z} )}^{2}}$$
and As₀ is a zero-order analytic signal amplitude given by:
As₀=\sqrt{f²+Hₓ²+H_{y}²}
where Hₓ and H_{y} are two orthogonal Hilbert transforms of the data.

2. The system according to claim 1 wherein the data processor retrieves a value of f from the memory.

3. The system according to claim 2 wherein the data processor uses the retrieved value of f to compute gradients of a magnetic field being df/dx, df/dy, and df/dz.

4. The system according to claim 1 wherein the data processor retrieves the values of df/dx, df/dy, and df/dz from the memory.

5. The system according to claim 3 wherein the data processor uses the gradients df/dx, df/dy, and df/dz to compute the analytic signal amplitude As.

6. The system according to claim 5 wherein the data processor computes two orthogonal Hilbert transforms of the data.

7. The system according to claim 6 wherein the data processor uses the computed Hilbert transforms to compute the zero-order analytic signal amplitude As₀.

8. The system according to claim 6 wherein the data processor uses a user selected value of N to calculate the relevant r value.

9. A system for interpreting aeromagnetic data, the system comprising:
a memory for storing therein aeromagnetic data; and
a data processor for accessing the data stored in the memory and processing the data according to the following formulae:
$$r = \frac{( N + 1 ) As}{{As}_{2}}$$
where r represents a depth of the magnetic source;
N is a structural index, which defines a type of source;
As is an analytic signal amplitude of a magnetic field f, given by:
$$As = \sqrt{{( \frac{\partial f}{\partial x} )}^{2} + {( \frac{\partial f}{\partial y} )}^{2} + {( \frac{\partial f}{\partial z} )}^{2}}$$
and As₂ is a second order analytic signal amplitude given by:
$${As}_{2} = \sqrt{{( \frac{\partial As}{\partial x} )}^{2} + {( \frac{\partial As}{\partial y} )}^{2} + {( \frac{\partial As}{\partial z} )}^{2}}$$

10. The system according to claim 9 wherein the data processor retrieves a value of f from the memory.

11. The system according to claim 10 wherein the data processor uses the retrieved value of f to compute gradients of a magnetic field being df/dx, df/dy, and df/dz.

12. The system according to claim 10 wherein the data processor retrieves the values of df/dx, df/dy, and df/dz from the memory.

13. The system according to claim 11 wherein the data processor uses the gradients df/dx, df/dy, and df/dz to compute the analytic signal amplitude As.

14. The system according to claim 13 wherein the data processor computes the gradient of the analytic signal amplitude As to arrive at a second order analytic signal amplitude As₂.

15. The system according to claim 14 wherein the data processor uses a user selected value of N to calculate the relevant r value.

16. A system for interpreting aeromagnetic data, the system comprising:
a memory for storing therein aeromagnetic data; and
a data processor for accessing the data stored in the memory and processing the data according to the following formulae:
$$r = \frac{( N + 1 )}{{As}_{T}}$$
where r represents a depth of the magnetic source;
N is a structural index, which defines a type of source;
and As_{T} is an analytic signal amplitude of a Tilt Angle T where:
$$T = {tan}^{- 1} ( \frac{\frac{\partial f}{\partial z}}{\sqrt{( {( \frac{\partial f}{\partial x} )}^{2} + {( \frac{\partial f}{\partial y} )}^{2} )}} )$$
$$and$$
$${AS}_{T} = \sqrt{{( \frac{\partial T}{\partial x} )}^{2} + {( \frac{\partial T}{\partial y} )}^{2} + {( \frac{\partial T}{\partial z} )}^{2}}$$

17. The system according to claim 16 wherein the data processor retrieves a value of f from the memory.

18. The system according to claim 17 wherein the data processor uses the retrieved value of f to compute gradients of a magnetic field being df/dx, df/dy, and df/dz.

19. The system according to claim 17 wherein the data processor retrieves the value of df/dx, df/dy, and df/dz from the memory.

20. The system according to claim 18 wherein the data processor uses the gradients df/dx, df/dy, and df/ dz to compute the Tilt Angle T.

21. The system according to claim 20 wherein the data processor uses T to compute the analytic signal amplitude AsT.

22. The system according to claim 21 wherein the data processor uses a user selected value of N to calculate the relevant r value.

23. A system for interpreting aeromagnetic data, the system comprising:
a memory for storing therein aeromagnetic data; and
a data processor for accessing the data stored in the memory and processing the data according to the following formulae:
$${T}_{As} = {tan}^{- 1} ( \frac{\frac{\partial As}{\partial z}}{\sqrt{( {( \frac{\partial As}{\partial x} )}^{2} + {( \frac{\partial As}{\partial y} )}^{2} )}} )$$
where T_{AS} is a tilt angle and Δx and Δz are the horizontal and vertical distances to a magnetic body; and
once the T_{AS} has been calculated then the data processor calculates a depth to the magnetic sources by measuring a distance between contour lines of user-specified value.

24. The system according to claim 23 wherein the data processor retrieves a value of f from the memory.

25. The system according to claim 24 wherein the data processor uses the retrieved value of f to compute gradients of a magnetic field being df/dx, df/dy, and df/dz.

26. The system according to claim 23 wherein the data processor retrieves values of df/dx, df/dy, and df/dz from the memory.

27. The system according to claim 25 wherein the data processor uses the gradients df/dx, df/dy, and df/dz to compute an analytic signal amplitude As.

28. The system according to claim 27 wherein the data processor uses the analytic signal amplitude As to compute the gradient of the analytic signal to arrive at TAS.
